(19) United States
(12) Patent Application Publication
(10) Pub. No.: US 2024/0169141 A1
(43) Pub. Date: May 23, 2024

(54) BOOK REVIEW DISPLAY METHOD, DEVICE, COMPUTER APPARATUS AND NON-TRANSITORY COMPUTER-READABLE STORAGE MEDIUM

(71) Applicant: Beijing Zitiao Network Technology Co., Ltd., Beijing (CN)

(72) Inventor: Huijing NIE, Beijing (CN)

(21) Appl. No.: 18/512,771

(22) Filed: Nov. 17, 2023

(30) Foreign Application Priority Data
Nov. 18, 2022 (CN) 202211447266.1

(51) Int. Cl. G06F 40/106; G06F 3/0483; G06F 40/279

(52) U.S. Cl. CPC G06F 40/106; G06F 3/0483; G06F 40/279

(57) ABSTRACT

The disclosure provides a book review display method and device, computer apparatus and a storage medium, and the method includes: acquiring reading progress information of a first book; wherein the reading progress information is used to indicate chapter that has been read by a user of the first book; determining a reading mode of the first book based on the reading progress information, and acquiring first review information of the chapter that has been read matching the reading mode; wherein the first review information is determined based on a book-related content corresponding to the reading progress information; and displaying the first review information on a book reading interface of the first book.

### CROSS REFERENCE TO RELATED APPLICATION

This application claims priority from Chinese Patent Application No. 202211447266.1, filed on Nov. 18, 2022, the contents of which are hereby incorporated by reference in their entirety for all purposes.

### TECHNICAL FIELD

The present disclosure relates to the technical field of computers, and specifically to a book review display method, device, computer apparatus, and storage medium.

### BACKGROUND

With the development of computer technology, novel online reading applications have more and more functions. For example, users can read books online in this application.

### SUMMARY

Embodiments of the present disclosure provide at least a book review display method, device, computer apparatus, and storage medium.

In one aspect, an embodiment of the present disclosure provides a method for displaying book review, including: acquiring reading progress information of a first book; wherein the reading progress information is used to indicate chapter that has been read by a user of the first book; determining a reading mode of the first book based on the reading progress information, and acquiring first review information of the chapter that has been read matching the reading mode ; wherein the first review information is determined based on a book-related content corresponding to the reading progress information; and displaying the first review information on a book reading interface of the first book.

In an optional implementation, the first review information is determined in a following manner including: determining, among the book-related contents of the first book, the book-related content matching the reading progress information; wherein the book-related contents include: review information of the first book and/or book-related topics of the first book; determining the first review information based on the matched book-related content.

In an optional implementation, determining the first review information based on the matched book-related content includes: in a case where the reading mode is a first reading mode, acquiring alternative review information matching the reading progress information from the review information of the first book; wherein the first reading mode is used to indicate that the chapter that has been read does not include the last chapter; determining, among the alternative review information, one piece of the alternative review information that meets a review quality requirement for the chapter that has been read, and determining the first review information based on the one piece of the alternative review information that meets the review quality requirement

In an optional implementation, determining the first review information based on the matched book-related content includes: in a case where the reading mode is a second reading mode, determining, among the book-related topics of the first book, a first book-related topic matching the reading progress information; wherein the second reading mode is used to indicate that the chapter that has been read includes last chapter; determining the first review information based on the first book-related topic.

In an optional implementation, the first review information includes a topic expansion identifier; the method further includes: in response to a triggering operation on the topic expansion identifier, jumping to a topic aggregation page; displaying a second book-related topic on the topic aggregation page; wherein the second book-related topic is a topic belonging to a target dimension among the book-related topics, and the target dimension includes at least one of: a target content type of a topic content, or a target creation type of the related book.

In an optional implementation, the first review information includes text review information; and displaying the first review information on the book reading interface of the first book includes: extracting key text information from the text review information; displaying the key text information in a review display area other than the display area of the first book in the book reading interface, and displaying a text expansion identifier; in response to a triggering operation on the text expansion identifier, displaying the text review information in the review display area.

In an optional implementation, the method further includes: in a case where the triggering operation on the text expansion identifier is not detected and a reading operation on a target chapter of the first book is detected, acquiring second review information matching the target chapter; wherein the target chapter is another chapter after the chapter that has been read; determining a position of a designated chapter in the book reading interface; wherein the position of the designated chapter is an area other than a chapter content of the target chapter in the book reading interface; and displaying the second review information at the position of the designated chapter.

In an optional implementation, displaying the first review information on the book reading interface of the first book includes: determining whether the review display area other than the display area of the first book in the book reading interface meets a display requirement; in a case where the display requirement is met, displaying the first review information in the review display area of the book reading interface; wherein it is indicated that the first review information and part of a chapter content of the chapter that has been read are displayed on the same book reading interface when the display requirement is met.

In another aspect, an embodiment of the present disclosure also provides a book review display device, including: acquisition unit, configured to acquire reading progress information of a first book; wherein the reading progress information is used to indicate chapter that has been read by a user of the first book; determination unit, configured to determine a reading mode of the first book based on the reading progress information, and acquiring first review information of the chapter that has been read matching the reading mode; wherein the first review information is determined based on a book-related content corresponding to the reading progress information; display unit configured to display the first review information on a book reading interface of the first book.

In another aspect, embodiments of the present disclosure also provide a computer apparatus, including a processor, a memory, and a bus, wherein the memory stores machine-readable instructions executable by the processor, when the computer apparatus is running, the processor communicates with the memory through the bus, and when the machine-readable instructions are executed by the processor, the steps of the above first aspect and any possible implementations of the first aspect are performed.

In another aspect, embodiments of the present disclosure also provide a computer-readable storage medium, a computer program is stored on the computer-readable storage medium, and the computer program is executed by a processor to perform the steps of the above first aspect and any possible implementations of the first aspect.

In the embodiment of the present disclosure, the reading progress information of the first book is first acquired, so as to determine the chapter that has been read by the user of the first book based on the reading progress information. Then, the reading mode of the first book can be determined based on the reading progress information. For example, it can be determined whether the reading mode is skim reading mode or deep reading mode. Next, the first review information of the chapter that has been read matching the reading mode can be acquired. For example, the first review information of the chapter that has been read matching the deep reading mode can be acquired. After that, the first review information can be displayed in the book reading interface of the first book.

In order to make the above-mentioned objects, features and advantages of the present disclosure more obvious and understandable, preferred embodiments are given below and described in detail with reference to the accompanying drawings.

### BRIEF DESCRIPTION OF THE DRAWINGS

In order to explain the technical solutions of the embodiments of the present disclosure more clearly, the drawings required to be used in the embodiments will be briefly introduced below. The drawings here are incorporated into the specification and constitute a part of this specification. These drawings illustrate embodiments consistent with the present disclosure and, together with the description, serve to explain the technical solutions of the present disclosure. It should be understood that the following drawings only illustrate certain embodiments of the present disclosure, and therefore should not be regarded as limiting the scope. For those of ordinary skill in the art, without exerting creative efforts, they can also Other relevant drawings are acquired based on these drawings.

FIG. 1 shows a flow chart of a book review display method provided by an embodiment of the present disclosure;

FIG. 2 shows a schematic diagram of a book reading interface provided by an embodiment of the present disclosure;

FIG. 3 shows a schematic style diagram of a review display area provided by an embodiment of the present disclosure;

FIG. 4 shows a schematic diagram of another book reading interface provided by an embodiment of the present disclosure;

FIG. 5 shows a schematic diagram of a book review display device provided by an embodiment of the present disclosure;

FIG. 6 shows a schematic diagram of a computer device provided by an embodiment of the present disclosure.

### DETAILED DESCRIPTION

It can be understood that before using the technical solutions disclosed in the embodiments of this disclosure, users should be informed of the type, scope of use, usage scenarios of the personal information involved in this disclosure in an appropriate manner in accordance with relevant laws and regulations and acquire the user's authorization.

In order to make the purpose, technical solutions and advantages of the embodiments of the present disclosure clearer, the technical solutions in the embodiments of the present disclosure will be clearly and completely described below with reference to the accompanying drawings in the embodiments of the present disclosure. Obviously, the described embodiments are only part of the embodiments of the present disclosure, but not all embodiments. The components of the embodiments of the present disclosure generally described and illustrated in the figures herein can be arranged and designed in a variety of different configurations. Therefore, the following detailed description of the embodiments of the disclosure provided in the appended drawings is not intended to limit the scope of the claimed disclosure, but rather to represent selected embodiments of the disclosure. Based on the embodiments of the present disclosure, all the other embodiments acquired by those skilled in the art without any creative efforts shall fall within the scope of protection of the present disclosure.

It should be noted that similar reference numerals and letters represent similar items in the following figures, therefore, once an item is defined in one figure, it does not need further definition and explanation in subsequent figures.

The term “and/or” in this article only describes an association relationship, indicating that there can be three relationships. For example, A and/or B can mean the following three situations: there is only A, there are A and B simultaneously, and there is only B. In addition, the term “at least one” herein means any one of a plurality or any combination of at least two of a plurality, for example, including at least one of A, B, and C, which can mean including one or more elements selected from the set composed of A, B and C.

Research has found that with the development of computer technology, novel online reading applications have more and more functions. For example, users can read books online in this application. However, when the user wants to know the relevant book review information of the book, he/she needs to exit the current online reading interface and enter the book review page to view it, which increases the operational complexity of the application and affects the user experience.

Based on the above research, the present disclosure provides a book review display method, device, computer apparatus and storage medium. In the embodiment of the present disclosure, the reading progress information of the first book is first acquired, so as to determine the chapter that has been read by the user of the first book based on the reading progress information. Then, the reading mode of the first book can be determined based on the reading progress information. For example, it can be determined whether the reading mode is skim reading mode or deep reading mode. Next, the first review information of the chapter that has been read matching the reading mode can be acquired. For example, the first review information of the chapter that has been read matching the deep reading mode can be acquired. After that, the first review information can be displayed in the book reading interface of the first book.

In the above embodiment, by determining the reading mode of the first book based on the reading progress information of the first book, a mode for determining the first review information can be acquired, and the book-related content associated with the reading progress information is determined according to the mode. Through this processing method, review information that better matches the chapter that has been read can be acquired. By displaying the determined first review information in the book reading interface of the first book, it is possible to display the review of the chapter that has been read to the user while the user is reading the first book. This processing mode does not require exiting the current book reading page and entering the book review page. Therefore, this processing mode can shorten the path for viewing the book review, simplify the process of viewing the book review, and improve the user experience.

To facilitate understanding of this embodiment, a book review display method disclosed in an embodiment of the present disclosure is first introduced in detail. The execution subject of the book review display method provided by an embodiment of the present disclosure is generally a computer device with certain computing capabilities.

Referring to FIG. 1, it shows a flow chart of a book review display method provided by an embodiment of the present disclosure. The method includes steps S101 to S105, wherein:

S101: acquire the reading progress information of the first book; wherein the reading progress information is used to indicate the chapter that has been read by the user of the first book.

Here, the first book can be understood as the electronic book read by the user currently; wherein, the electronic book can contain multiple chapters, and each chapter contains a corresponding chapter title, such as “Chapter One, Encounter with XXX” and so on. In addition, it also contains chapter content, wherein the chapter content can be understood as the content of the book corresponding to the chapter.

In this embodiment of the present disclosure, the reading progress information can be: the chapter that has been read of the first book at the current moment, and/or other progress information; wherein the other progress information can be understood as the information having a mapping relationship with the chapters of the book.

For example, the other progress information can be at least one of the following information: the current number of pages that have been read of the first book, for example, page N; the current number of words that have been read of the first book, and other information.

Here, there is a corresponding mapping relationship between the number of pages of the first book and the chapters of the book. Therefore, the chapter that has been read of the first book can be acquired based on the mapping with the current number of pages that have been read. Similarly, there is a corresponding mapping relationship between the number of words of the first book and the chapters of the book. Therefore, the chapter that has been read of the first book can be acquired based on the mapping with the current number of words that have been read.

During specific implementation, the user's current number of pages that have been read of the first book can be acquired, and then the reading progress information can be determined based on the current number of pages that have been read. Here, the chapter that has been read can be determined based on the chapter corresponding to the current number of pages that have been read. The user's current number of words of the first book that have been read can also be acquired, and then the reading progress information can be determined based on the current reading information. Here, the chapter that has been read can be determined based on the chapter corresponding to the current number of words that have been read.

Here, the chapter that has been read may be the last chapter of the first book, or may not be the last chapter of the first book.

The first book can be a book that has been completed or a book that is being updated. At this time, in the case where the first book is a book being updated, the last chapter of the first book can be understood as the last updated chapter.

S103: determine the reading mode of the first book based on the reading progress information, and acquire the first review information of the chapter that has been read matching the reading mode; wherein the first review information is determined based on a book-related content matching the reading progress information.

In an embodiment of the present disclosure, the reading mode of the first book is associated with the position of the chapter that has been read in all chapters of the first book. For example, if the chapter that has been read is not the last chapter, then the reading mode of the first book can be the first reading mode, that is, the skim reading mode. As another example, if the chapter that has been read is the last chapter, then the reading mode of the first book can be the second reading mode, that is, the deep reading mode.

Here, the skim reading mode can be divided into multiple levels of sub-modes, wherein the chapter that has been read corresponding to each level of sub-mode have different positions in all chapters. For example, the skim reading mode can be divided into a first-level sub-mode, a second-level sub-mode, and a third-level sub-mode. Among them, the chapter that has been read corresponding to the first-level sub-mode can be understood as the first ¼ chapters of all chapters. The chapter that has been read corresponding to the second-level sub-mode can be understood as the first 2/4 chapters of all chapters. The chapter that has been read corresponding to the third-level sub-mode can be understood as the first ¾ chapters of all chapters.

Here, the skim reading mode can be divided into multiple levels of sub-modes based on the characteristics of the book attribute of the first book. For example, for different types of books, different numbers of sub-modes and the positions of chapter that has been read corresponding to each sub-mode can be provided.

In an optional implementation, the chapter that has been read of the first book can be determined based on the reading progress information of the first book. In the case where it is determined based on the reading progress information that the chapter that has been read is not the last chapter of the first book, the above reading mode can be determined to be the first reading mode, that is, the skim reading mode. In the case where it is determined based on the reading progress information that the chapter that has been read is the last chapter of the first book, it can be determined that the above reading mode is the second reading mode, that is, the deep reading mode.

In another optional implementation, the chapter that has been read of the first book can be determined based on the reading progress information of the first book, and the number of chapters corresponding to the chapter that has been read can be determined, for example, the Nth chapter. Afterwards, it can be determined whether the number of chapters meets the preset requirements.

In the case where it is determined that the number of chapter that has been read does not meet the preset number requirement, it can be determined that the reading mode of the first book is the first reading mode, that is, the skim reading mode. In the case where it is determined that the number of chapter that has been read meets the preset number requirement based on the reading progress information, it can be determined that the reading mode of the first book is the second reading mode, that is, the deep reading mode.

For the above two embodiments, in the case where it is determined that the reading mode is the skim reading mode, the chapter that has been read can also be compared with the chapter range of the chapter that has been read corresponding to each sub-mode, thereby determining the sub-mode corresponding to the chapter that has been read. Therefore, the reading mode of the first book is determined based on the matched sub-mode, thereby achieving subdivision of the reading mode.

In the embodiment of the present disclosure, after the reading mode of the first book is determined, the first review information of the chapter that has been read matching the reading mode can be acquired.

Here, the first review information can be related book review of the chapter that has been read of the first book, or book-related topics of the first book, or recommendation information for other books related to the first book. At this time, the recommendation information can include information such as book titles, book authors, book recommendation reasons and so forth of other related books. Among them, other books related to the first book can be understood as books that contain the same characteristics as the first book, such as fan works, secondary creation works, works with the same book friends, works by the same author, works of the same type, etc.

S105: display the first review information on the book reading interface of the first book.

In the embodiment of the present disclosure, after the first review information is acquired, the first review information can be displayed on the book reading interface of the first book.

In the embodiment of the present disclosure, the reading progress information of the first book is first acquired, so as to determine the chapter that has been read by the user of the first book based on the reading progress information. Then, the reading mode of the first book can be determined based on the reading progress information. For example, it can be determined whether the reading mode is skim reading mode or deep reading mode. Next, the first review information of the chapter that has been read matching the reading mode can be acquired. For example, the first review information of the chapter that has been read matching the deep reading mode can be acquired. After that, the first review information can be displayed in the book reading interface of first book.

In the above embodiment, by determining the reading mode of the first book based on the reading progress information of the first book, a determination method of the first review information can be provided, and the first review information is determined in the book-related content associated with the reading progress information according to the determination method. Through this processing method, review information that better matches the chapter that has been read can be acquired. By displaying the determined first review information in the book reading interface of the first book, it is possible to display the review of the chapter that has been read to the user while the user is reading the first book. This processing method does not require exiting the current reading page and entering the book review page. Therefore, this processing method can shorten the path for viewing the book review, simplify the process of viewing the book review, and improve the user experience.

In this embodiment of the present disclosure, the above-mentioned first review information can be determined in the following manner, specifically including the following steps:

Step S11: determine, among the book-related contents of the first book, the book-related content matching the reading progress information; wherein the book-related contents includes: review information of the first book and/or the book-related topics for first book;

Step S12: determine the first review information based on the matched book-related content.

Here, the review information of the first book can be understood as the review information posted by the user who reads the first book in the application with respect to at least part of the chapter contents of the chapter. For example, the review information can be the user's thoughts after reading the chapter in the first book, or the user's discussion of relevant characters in the first book, or the user's discussion of relevant plots in the first book, and so forth.

Here, the book-related topics of the first book can be a discussion topics associated with the first book in the application, wherein the book-related topics can be the topics included in the book circle of the first book, or it can be the first book-related topic published in the topic square of the application.

In the embodiment of the present disclosure, among various types of book-related contents of the first book, the book-related content matching the reading mode of the first book can be determined. For example, the book-related content matching the skim reading mode is the review information of the first book, and the book-related content matching the deep reading mode is the book-related topic of the first book. Afterwards, the first review information can be determined based on the book-related content matching the reading progress information acquired from the matched book-related contents.

For the skim reading mode, among the review information of the first book, the review information matching the reading progress information can be determined as the first review information. For the deep mode, among the book-related topics of the first book, the book-related topic matching the reading progress information can be determined as the first review information.

The process of determining the first review information based on the matched book-related content will be described in detail below with reference to the skim reading mode and the deep mode.

### Reading Mode 1: Skim Reading Mode.

In this case, the above-mentioned step S12 of determining the first review information based on the matched book-related content specifically includes the following steps:

Step S21: in a case where the reading mode is the first reading mode (that is, skim reading mode), acquire alternative review information matching the reading progress information from the review information of the first book; wherein the first reading mode is used to indicate that the chapter that has been read does not include the last chapter.

Step S22: determine, among the alternative review information, one piece of the alternative review information that meets the review quality requirement for the chapter that has been read, and determine the first review information based on the one piece of the alternative review information that meets the review quality requirements.

In the embodiment of the present disclosure, the alternative review information can be understood as the review information associated with the chapter that has been read indicated by the reading progress information among all review information of the first book. For example, the alternative review information can be character review information for characters appearing in the chapter that has been read, plot review information for a certain plot segment in the chapter that has been read, and various other types of review information.

Here, alternative review information can be determined in the following ways.

### Determination Method 1:

In the case where the review information includes a review identification, the review identification of each review information in the first book can be acquired; wherein the review identification can be used to indicate at least one of the following: the chapter corresponding to the review information, the type of review (for example, a character review or a plot review) of the review information, and the review content of the review information (for example, a review about XX character, or a review about the BBB plot).

Next, alternative review information matching the reading progress information can be determined based on the review identifier of the review information.

During specific implementation, review filtering information can be determined, wherein the review filtering information can be used to indicate the review type and/or review content of the review information. After that, the review filtering information can be matched with the review identifier, so that the review information corresponding to the review filtering information is determined as the alternative review information.

### Determination Method 2:

The review key information of each review information can be extracted. Then the matching degree between the review key information and the chapter that has been read is determined, thereby the review information having a matching degree greater than or equal to the preset matching degree threshold is determined as alternative review information.

After the alternative review information is determined, the alternative review information that meets the review quality requirements can be determined from the alternative review information.

Here, the review quality requirements can include at least one of the following: review word number requirements, like number requirements, content popularity requirements, publication time requirements, praise rating requirements and so forth. For example, it can be determined that the alternative review information having number of likes greater than or equal to 30 and having number of words greater than 100 words meets the review quality requirements. After that, the alternative review information that meets the review quality requirements can be determined as the first review information.

In the above embodiment, in a case where the reading mode is the first reading mode (that is, the chapter that has been read does not include the last chapter), the alternative review information that matches the reading progress information (that is, matching the chapter that has been read) is acquired from the review information of the first book, thereby preventing the alternative review information from exposing the relevant content of the chapter that has not been read in the first book. Afterwards, among the alternative review information, the first review information can be determined based on the alternative review information that meets the review quality requirements, so that the quality of the acquired first review information can be improved to provide the user with the first review information of more value.

### Reading Mode 2: Deep Reading Mode:

In this case, the above-mentioned step S22 of determining the first review information based on the matched book-related content specifically includes the following steps:

Step S31: in a case where the reading mode is the second reading mode (that is, the deep reading mode), determine, among the book-related topics of the first book, the first book-related topic that matches the reading progress information; wherein, the second reading mode is used to indicate that the chapter that has been read includes the last chapter;

Step S32: determine the first review information based on the first book-related topic.

In the embodiment of the present disclosure, first, among the book topics included in the application, the book-related topic of the first book can be determined.

During specific implementation, the topics included in the book circle corresponding to the first book can be determined as the book-related topics of the first book. Among them, the book circle includes all content associated with the first book in the application, such as book topics, book announcement information, book-related activity information and other types of information.

In addition, among the book topics published in the topic square in the application, the book topic associated with the first book can also be determined as the book-related topic of the first book, wherein the topic square is the functional module used to publish book-related topics in the application.

After the book-related topics of the first book are determined, among the above-mentioned book-related topics, the first book-related topic matching the reading progress information can be determined.

During specific implementation, the topic identifier of each book-related topic in the book-related topics of the first book can be acquired; wherein, the topic identifier can be used to indicate at least one of the following: the title of the book corresponding to the book-related topics, the topic content type of the book-related topics (for example, character-based topic or plot-based topic), and the creation type of books related to the book-related topic (for example, fan works, secondary creation works and so forth).

Next, the first book-related topic that matches the reading progress information can be determined based on the topic identifier of the book-related topics.

During specific implementation, the topic filtering information can be determined, wherein the topic filtering information can be used to indicate at least one of the content type of the required book topics, and the title and the creation type of the related book. Afterwards, the topic filtering information can be matched with the topic identifier, thereby the book-related topic corresponding to the topic filtering information is determined as the first book-related topic.

In the embodiment of the present disclosure, the topic identifier can be determined based on the topic tag of the book-related topics, or can also be determined based on the key topic contents of the topics associated with the book.

In the embodiment of the present disclosure, after the first book-related topic is determined, the first review information can be determined based on the first book-related topic.

During specific implementation, the first book-related topic can be sorted according to preset sorting parameters so as to acquire topic sorting results, wherein the preset sorting parameters include at least one of the following: topic popularity, topic views, and relevancy with the first book. Afterwards, the first book-related topic in the topic sorting result that meets the preset sorting requirements can be determined as the first review information.

In the above embodiment, in the case where the reading mode is the second reading mode (that is, the chapter that has been read includes the last chapter), the first book-related topic that matches the reading progress information (that is, matches the chapter that has been read, or matches all chapters of the first book) is determined from the book-related topics of the first book, and the first review information is determined based on the first book-related topic. Therefore, the book reading module and the book topic module can be connected with each other, so that after finishing reading the first book, the user can directly acquire the topic content associated with the first book in the book topic module, avoiding the operation process of the user to jump to the module to view the relevant information, and improving the user's use fluency.

Following the above reading mode 2, in this case, the first review information can also include a topic expansion identifier. Based on this, the embodiment of the present disclosure specifically includes the following steps:

Step S41: in response to the triggering operation on the topic expansion identifier, jump to the topic aggregation page;

Step S42: display a second book-related topic on the topic aggregation page; wherein, the second book-related topic is a topic belonging to a target dimension among the book-related topics, and the target dimension includes at least one of the following: the target content type of the topic content, and the target creation type of the related book.

Here, the topic expansion identifier can be a triggerable graphic identifier or a triggerable symbol identifier, which is not specifically limited in this disclosure.

In the embodiment of the present disclosure, in the case where the reading mode is the second reading mode, in addition to displaying the first book-related topic on the book reading interface, a topic expansion identifier can also be displayed. By triggering the topic expansion identifier, one can request to display more book-related topics.

Therefore, in the embodiment of the present disclosure, the user's triggering operation on the topic expansion identifier can be detected, and then, in response to the triggering operation, the second book-related topic is acquired, and the topic aggregation page is displayed on the display screen of the computer device. Next, it allows to display the second book-related topics on the topic aggregation page.

Here, the second book-related topic may include the first book -related topic, or may not include the first book-related topic.

During specific implementation, target filtering features can be set, wherein the target filtering features belong to a target dimension, and the target dimension includes at least one of the following: a target content type of the topic content, and a target creation type of the related book.

Here, the target content type can be at least one of the following: plot discussion type, character discussion type, writing style discussion type, author discussion type, etc. The target creation type is used to indicate the creation type of the book corresponding to the book-related topics. For example, the target creation type can be imitation, adaptation, or fan creation, etc.

Here, the target filtering features can include at least one of the following: plot topics, character topics, author topics, writing style topics, topics about fan works, and topics about secondary creation works. Among them, the target dimensions to which plot topics, character topics, author topics and writing style topics belong are the target content type, and the target dimensions to which topics about fan works and topics about secondary creation works belong are the target creation type.

Based on this, the book-related topic that match the target filtering features can be selected from the book-related topics of the first book as the second book-related topic. Therefore, the second book-related topic belonging to the target dimension can be acquired.

At this time, an association relationship between each second book-related topic and the target dimension (or target filtering feature) can also be established.

In the embodiment of the present disclosure, after detecting the triggering operation on the topic expansion identifier, it allows to jump to the topic aggregation page, and display, on the topic aggregation page, the topic content matching the target content type and/or the creation content having the target creation type of the first book.

Based on this, while displaying the second book-related topic on the topic aggregation page, the target dimensions (or target filtering features) corresponding to each second book-related topic can also be displayed. If a triggering operation by the user on the target dimension (or target filtering feature) is detected, jump to the details page corresponding to the target dimension (or target filtering feature), and display the second book-related topic belonging to the target dimension (or target filtering feature) on the details page.

In the embodiment of the present disclosure, in response to the triggering operation on the topic expansion identifier, it jumps to the topic aggregation page, and the second book-related topic is displayed on the topic aggregation page, wherein the second book-related topic is a book-related topic that belongs to the target dimension. In the above embodiment, after the user has finished reading the first book, among the book-related topics, the topics belonging to the target dimension can be displayed, so that more review information that the user may be interested in can be displayed, thereby broadening the user's thinking and making the user understand the first book in a more comprehensive way.

In an optional implementation, in the case where the first review information includes text review information, the above step S105 of displaying the first review information on the book reading interface of the first book specifically includes the following steps:

Step S41: extract key text information from the text review information;

Step S42: display the key text information in the review display area other than the display area of the first book in the book reading interface, and display a text extension identifier;

Step S43: in response to the triggering operation on the text expansion identifier, display the text review information in the review display area.

In the embodiment of the present disclosure, the key text information can be understood as the text information with a higher frequency of occurrence in the text review information, it can also be the text information with a strong correlation with the first book, or it can be the top N text information in the text review information, wherein N is a natural number greater than 0.

In the embodiment of the present disclosure, the book reading interface can include a display area of the first book and a review display area, wherein the size of the display area of the first book can be determined based on the size of the chapter content to be displayed, and the size of the review display area can be a preset size, or can be determined based on the size of the remaining area other than the display area of the first book in the book reading interface.

In the embodiment of the present disclosure, the key text information in the text review information and the text extension identifier corresponding to the text review information can both be displayed in the review display area.

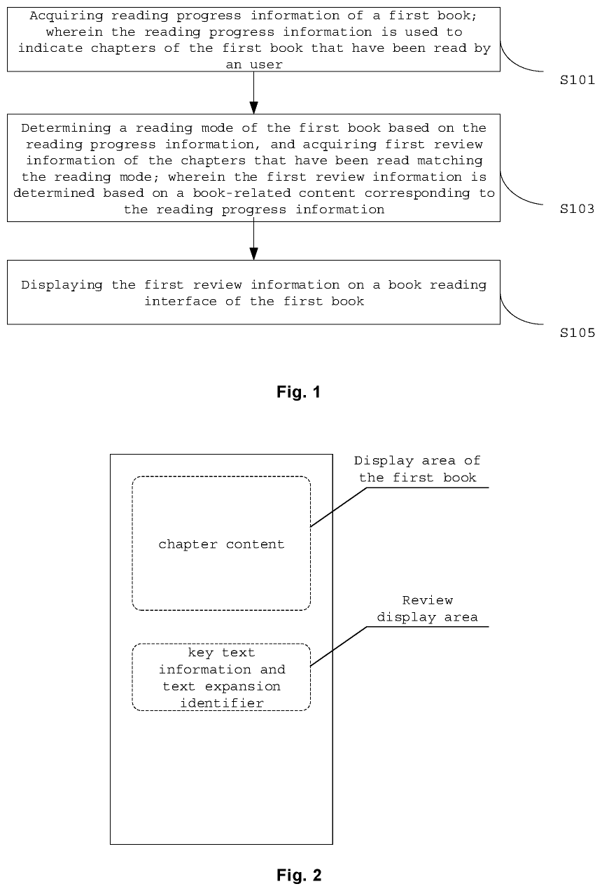

For example, a book reading interface as shown in FIG. 2 can display the chapter content of the first book in the display area of the first book as shown in FIG. 2, and display the key text information and corresponding text extension identifiers in the review display area as shown in FIG. 2.

It should be noted here that in addition to the above key text information and text extension identifiers, the review display area can also display at least one of the following: the area title information, the user identification information, the rating information, and the number of approvals. This disclosure does not specifically limit the contents displayed in the review display area.

In one possible implementation, as shown in Style 1 in FIG. 3, the area title “Popular Book Reviews”, the key text information “XXXXX” and the text extension identification “More Book Reviews” can be displayed in the review display area.

In another possible implementation, as shown in Style 2 in FIG. 3, the area title “Popular Book Reviews”, the user ID “User ID 1” corresponding to the user who published the text review information, the rating information “4.8 points”, the key text information “XXXXX”, and the text expansion identifier “More Book Reviews” can be displayed in the review display area.

In another possible implementation, as shown in Style 3 in FIG. 3, the area title “Popular Book Reviews” and the user ID “User ID 1” corresponding to the user who published the text review information, the key text information “XXXXX”, the text extension identifier “More Book Reviews” and the number of approvals “30 approvals” can be displayed in the review display area.

In the embodiment of the present disclosure, after detecting the triggering operation on the text expansion identifier, the text review information can be displayed in the review display area.

During specific implementation, in the case where the area other than the display area of the first book in the book reading interface can fully display the entire content of the text review information, the review display area can be expanded after the triggering operation on the text expansion identifier is detected, and the text review information can be displayed in the expanded review display area.

In the case where the entire content of the text review information cannot be fully displayed in the area other than the display area of the first book in the book reading interface, in a possible implementation, after detecting the triggering operation on the text expansion identifier, the review display area is expanded, and a sliding scroll wheel is provided in the review display area. At this time, the entire content of the text review information can be read by triggering the sliding scroll wheel. In another possible implementation, after detecting the triggering operation on the text expansion identifier, it can jump to the review display page so as to display the entire content of the text review information.

In the above embodiment, the key text information can be extracted from the text review information, and the key text information and the text extension identifier can be displayed in the review display area of the book reading interface, so that it allows to increase the review display area to provide the user with richer content without affecting the reading of the chapter content of the first book by the user. Afterwards, after detecting the triggering operation on the text expansion identifier, the text review information can be displayed in the review display area, thereby allowing the user to view the text review information more conveniently and quickly, and improving the convenience and efficiency of viewing the text review information.

It can be seen from the above disclosure that in the case where the user has finished reading the last page of the current chapter, the remaining chapter content of the current chapter can be displayed in the book reading interface corresponding to the last page, and the text reviews information and text extension identifiers matching the chapter that has been read can be displayed.

After detecting the triggering operation on the text identifier, the text review information can be displayed in the review display area.

If no triggering operation on the text extension identifier is detected, it can perform the following steps:

Step S51: in the case where the triggering operation on the text extension identifier is not detected and the reading operation on the target chapter of the first book is detected, acquire the second review information matching the target chapter; wherein, the target chapter is another chapter after the chapter that has been read;

Step S52: determine a position of a designated chapter in the book reading interface; wherein the position of the designated chapter is an area other than the chapter content of the target chapter in the book reading interface;

Step S53: display the second review information at the specified chapter position.

Here, the target chapter can be understood as the next chapter of the currently reading chapter in the first book, or it can be an arbitrarily specified chapter in the first book, wherein the arbitrarily specified chapter can be the chapter before the currently reading chapter, or it can be chapter after the currently reading chapter.

In the embodiment of the present disclosure, in the case where a reading operation on the target chapter of the first book is detected, the reading progress information of the first book can be reacquired to acquire new reading progress information.

In particular, the new reading progress information can be understood as: the chapter information corresponding to the target chapter in the first book, and/or other progress information; wherein, the other progress information can be understood as the information having a mapping relationship with the chapters of the book. For example, the other progress information can be at least one of the following information: the current number of pages that have been read in the first book, for example, page N; the current number of words that have been read in the first book, and other information.

For example, in the case where the target chapter is Chapter 100 of the first book, the new chapter that has been read can be determined to be Chapter 100. At this time, the new chapter that has been read can be determined as the new reading progress information.

In another possible implementation, the new chapter that has been read can be determined based on the historical reading record of the first book, and the new reading progress information can be determined based on the new chapter that has been read. For example, the new chapter that has been read can be determined based on the maximum chapter that has been read recorded in the historical reading record of the first book.

For example, in the case where the currently reading chapter is Chapter 80 and the target chapter is Chapter 100, it can be determined that the maximum chapter that has been read in the historical reading record is Chapter 100. At this time, it can be determined that the new chapter that has been read is Chapter 100. At this time, the new reading progress information can be determined to be Chapter 100. Alternatively, in the case where the currently reading chapter is Chapter 80 and the target chapter is Chapter 50, it can be determined that the maximum chapter that has been read in the historical reading record is Chapter 80. At this time, it can be determined that the new chapter that has been read is Chapter 80. At this time, it can be determined that the reading progress information is Chapter 80.

Afterwards, the reading mode of the first book can be determined based on the new reading progress information, and the review information of the chapter that has been read indicated by the new reading progress information matching the reading mode is acquired, and the review information is determined as the second review information.

In the embodiment of the present disclosure, the above position of the designated chapter can be an area in the book reading interface corresponding to the last page of the target chapter other than the chapter content of the target chapter. For example, the position of the designated chapter can indicate the chapter end of the target chapter. Alternatively, the position of the designated chapter can also be an area in the book reading interface corresponding to any page other than the chapter content of the target chapter in the target chapter. For example, the position of the designated chapter can also indicate a position between any two lines of chapter contents in the book reading interface.

In the above embodiment, the reading progress information of the user can be detected in real time, the review information matching the current reading progress information (that is, second review information) can be acquired in a timely manner, and the second review information can be displayed in the book reading interface at the position of the specified chapter. Therefore, user's need for review can be met promptly and accurately, giving the user a better browsing experience.

In an optional implementation, the above-mentioned step S105 of displaying the first review information on the book reading interface of the first book specifically further includes the following steps:

Step S61: determine whether the review display area other than the display area of the first book in the book reading interface meets the display requirements;

Step S62: in the case where it is determined that the display requirement is met, display the first review information in the review display area of the book reading interface; wherein it is indicated that the first review information and part of the chapter content of the chapter that has been read are displayed on the same book reading interface when the display requirement is met.

Here, meeting the display requirements can be understood as the area size corresponding to the area other than the display area of the first book in the book reading interface is greater than or equal to the minimum area size corresponding to the review display area.

Alternatively, meeting the display requirements can also be understood as meaning that the review display area does not need to be displayed independently in the book reading interface.

In the case where it is determined that the review display area meets the display requirements, the first review information can be displayed in the review display area of the book reading interface. In the case where it is determined that the review display area meets the non-display requirements, the first review information will no longer be displayed.

In the above embodiment, it allows to first determine whether the review display area in the book reading interface meets the display requirements, and in the case where it is determined that the display requirements are met, the first review information is displayed in the review display area, so that the display of the first review information does not affect the user's need for reading. Therefore, the user can be provided with richer relevant information while ensuring the user's reading experience.

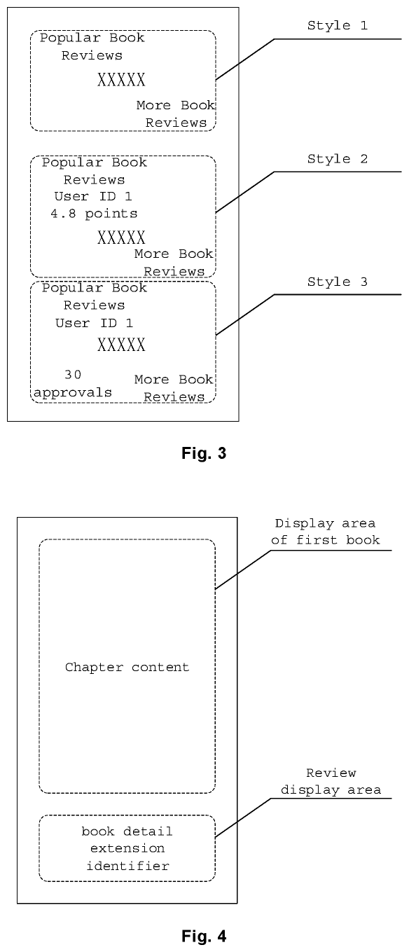

In another optional implementation, in the case where it is determined that the display requirements are met, the book detail extension identifier can be displayed in the review display area of the book reading interface. At this time, the book reading interface can be as shown in FIG. 4.

After detecting the triggering operation on the book detail extension identifier, it jumps to the book detail page. At this time, the book detail page can include the information about the corresponding author of the first book, the update information of the first book, the rating information and review information of the first book, etc.

Those skilled in the art can understand that in the above-mentioned methods of specific embodiments, the order of each step does not mean a strict execution order and does not constitute any limitation on the implementation. The specific execution order of each step should be determined based on its function and the possible internal logic.

Based on the same inventive concept, the embodiment of the present disclosure also provides a book review display device corresponding to the book review display method. Since the principle of solving the problem by the device in the embodiment of the present disclosure is similar to the above-mentioned book review display method of the embodiment of the present disclosure, the implementation of the device can refer to the implementation of the method, and the similar details will not be repeated.

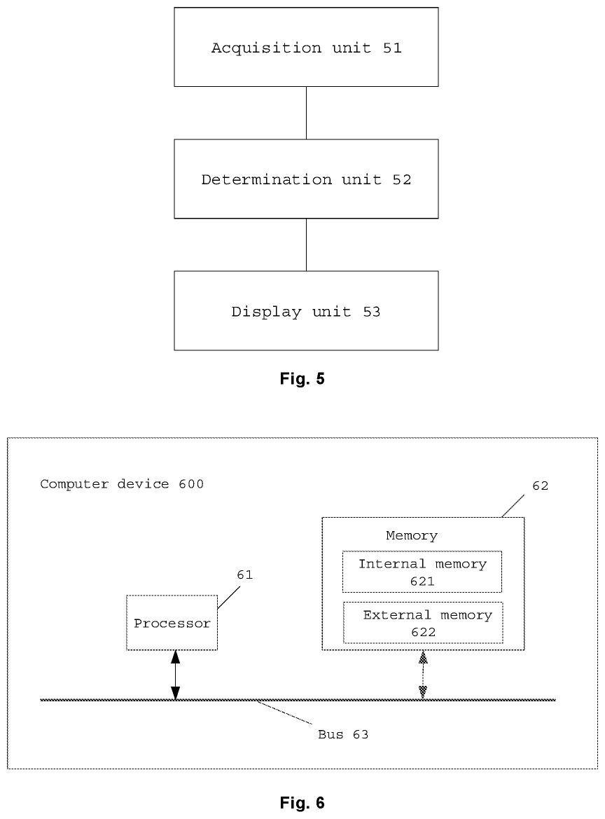

Referring to FIG. 5, a schematic diagram of a book review display device provided by an embodiment of the present disclosure is shown and the device includes: an acquisition unit 51, a determination unit 52, and a display unit 53.

The acquisition unit 51 is used to acquire the reading progress information of the first book; wherein the reading progress information is used to indicate chapter that has been read by the user of the first book;

The determination unit 52 is used to determine the reading mode of the first book based on the reading progress information, and acquire the first review information of the chapter that has been read that matching the reading mode; wherein the first review information is determined based on the book-related content corresponding to the reading progress information;

The display unit 53 is configured to display the first review information on the book reading interface of the first book.

It can be seen from the above description that the reading progress information of the first book can be acquired first, and the reading mode of the first book is determined based on the reading progress information. Wherein, the reading progress information can indicate the chapter that has been read of the first book. After that, the first review information of the chapter that has been read matching the reading mode is acquired, and the first review information is displayed in the book reading interface of the first book.

In the above embodiment, the first review information of the chapter that has been read can be determined based on the user's reading progress information of the first book and the reading mode of the first book, so that the user can acquire much more and more comprehensive review information that is associated with the chapter that has been read of the first book. Afterwards, the first review information can be displayed in the book reading interface of the first book, thereby avoiding the need for the user to exit the current reading state and enter the book review page to view the review information related to the first book, simplifying the path for the user to view the book review and improving the user experience.

In a possible implementation, the determination unit 52 is further configured to determine, among the book-related contents of the first book, the book-related content matching the reading progress information; wherein the book-related contents include: review information of the first book and/or book-related topics of the first book; and determine the first review information based on the matched book-related content.

In a possible implementation, the determination unit 52 is further configured to: in a case where the reading mode is a first reading mode, acquire alternative review information matching the reading progress information from the review information of the first book; wherein the first reading mode is used to indicate that the chapter that has been read does not include last chapter; and determine, among the alternative review information, one piece of the alternative review information that meets a review quality requirement for the chapter that has been read, and determine the first review information based on the one piece of the alternative review information that meets the review quality requirement.

In a possible implementation, the determination unit 52 is further configured to: in a case where the reading mode is a second reading mode, determine, among the book-related topics of the first book, a first book-related topic matching the reading progress information; wherein the second reading mode is used to indicate that the chapter that has been read includes last chapter; and determine the first review information based on the first book-related topic.

In a possible implementation, the determination unit 52 is further configured to: in the case where the first review information includes a topic expansion identifier, in response to a triggering operation on the topic expansion identifier, jump to a topic aggregation page; and display a second book-related topic on the topic aggregation page; wherein the second book-related topic is a topic belonging to a target dimension among the book-related topics, and the target dimension includes at least one of: a target content type of a topic content, or a target creation type of the related book.

In a possible implementation, the display unit 53 is further configured to: in the case where the first review information includes text review information, extract key text information from the text review information; display the key text information in a review display area other than the display area of the first book in the book reading interface, and displaying a text expansion identifier; and in response to a triggering operation on the text expansion identifier, display the text review information in the review display area.

In a possible implementation, the display unit 53 is also configured to: in a case where the triggering operation on the text expansion identifier is not detected and a reading operation on a target chapter of the first book is detected, acquire second review information matching the target chapter; wherein the target chapter is another chapter after the chapter that has been read; determine a position of a designated chapter in the book reading interface; wherein the position of the designated chapter is an area other than a chapter content of the target chapter in the book reading interface; and display the second review information at the position of the designated chapter.

In a possible implementation, the display unit 53 is also used to: determine whether the review display area other than the display area of the first book in the book reading interface meets a display requirement; in a case where the display requirement is met, display the first review information in the review display area of the book reading interface; wherein it is indicated that the first review information and part of a chapter content of the chapter that has been read are displayed on the same book reading interface when the display requirement is met.

For the description of the processing flow of each module in the device and the interaction flow between the modules, it can be referred to the relevant descriptions in the above method embodiments, and will not be described in detail here.

Corresponding to the book review display method in FIG. 1, an embodiment of the present disclosure also provides a computer device 600. As shown in FIG. 6, a schematic structural diagram of the computer device 600 provided by an embodiment of the present disclosure is shown and it includes:

Processor 61, memory 62, and bus 63. The memory 62 is used to store execution instructions, including internal memory 621 and external memory 622. The internal memory 621 here is also called internal memory, and is used to temporarily store operation data in processor 61, and exchanges data with the external memory 622 such as a hard disk with The processor 61 exchanges data with the external memory 622 through the internal memory 621. When the computer device 600 is running, the processor 61 and the memory 62 communicate with each other through the bus 63, so that the processor 61 executes the following instructions:
acquire reading progress information of a first book; wherein the reading progress information is used to indicate chapter that has been read by a user of the first book;
determine a reading mode of the first book based on the reading progress information, and acquiring first review information of the chapter that has been read matching the reading mode; wherein the first review information is determined based on a book-related content corresponding to the reading progress information; and
display the first review information on a book reading interface of the first book.

Embodiments of the present disclosure also provide a computer-readable storage medium. A computer program is stored on the computer-readable storage medium. When the computer program is executed by a processor, the computer program performs the steps of the book review display method described in the above method embodiment. Wherein the storage medium can be a volatile or non-volatile computer-readable storage medium.

Embodiments of the present disclosure also provide a computer program product. The computer program product carries program code. The instructions included in the program code can be used to execute the steps of the book review display method described in the above method embodiment. The details can be seen in the above method embodiments and will not be described again here.

In particular, the above-mentioned computer program product can be specifically implemented by hardware, software or a combination thereof. In an optional embodiment, the computer program product is embodied as a computer storage medium. In another optional embodiment, the computer program product is embodied as a software product, such as a Software Development Kit (SDK), etc.

Those skilled in the art can clearly understand that for the convenience and simplicity of description, the specific working processes of the systems and devices described above can refer to the corresponding processes in the foregoing method embodiments, and will not be described again here. In the several embodiments provided in this disclosure, it should be understood that the disclosed systems, devices and methods can be implemented in other ways. The device embodiments described above are only illustrative. For example, the division of the units is only a logical function division. In actual implementation, there can be other division methods. For example, multiple units or components can be combined with or can be integrated into another system, or some features can be ignored, or not implemented. On the other hand, the shown or discussed coupling or direct coupling or communication connection between each other can be through some communication interfaces, and the indirect coupling or communication connection of the devices or units can be in electrical, mechanical or other forms.

The units described as separate components may or may not be physically separated, and the components shown as one unit may or may not be physical units, that is, they can be located in one place, or they can be distributed to multiple network units. Some or all of the units can be selected according to actual needs to achieve the purpose of the solution of this embodiment.

In addition, each functional unit in various embodiments of the present disclosure can be integrated into one processing unit, or each unit can exist physically alone, or two or more units can be integrated into one unit.

If the functions are implemented in the form of software functional units and sold or used as independent products, they can be stored in a non-volatile computer-readable storage medium that is executable by a processor. Based on this understanding, the essentially technical solution of the present disclosure or the part that contributes to the existing technology or the part of the technical solution can be embodied in the form of a software product. The computer software product is stored in a storage medium, including several instructions for causing a computer device (which can be a personal computer, a server, or a network device and so forth) to execute all or part of the steps of the methods described in various embodiments of the present disclosure. The aforementioned storage media include: USB disk, mobile hard disk, Read-Only Memory (ROM), Random Access Memory (RAM), magnetic disk or optical disk and other media that can store program codes.

Finally, it should be noted that the above-mentioned embodiments are specific implementations of the present disclosure and are used to illustrate the technical solutions of the present disclosure rather than to limit them. The protection scope of the present disclosure is not limited thereto. Although the present disclosure has been described in detail with reference to the foregoing embodiments, those skilled in the art should understand that: any person familiar with the technical field can still modify the technical solutions recorded in the foregoing embodiments within the technical scope disclosed in the present disclosure and can easily think of changes, or make equivalent substitutions to some of the technical features. These modifications, changes or substitutions do not cause the essence of the corresponding technical solutions to deviate from the spirit and scope of the technical solutions of the embodiments of the present disclosure, and shall be included within the scope of protection of the present disclosure. Therefore, the protection scope of the present disclosure should be determined by the protection scope of the claims.

What is claimed is:

1. A method for displaying book review, comprising:
acquiring reading progress information of a first book; wherein the reading progress information is used to indicate chapter that has been read by a user of the first book;
determining a reading mode of the first book based on the reading progress information, and acquiring first review information of the chapter that has been read matching the reading mode; wherein the first review information is determined based on a book-related content corresponding to the reading progress information; and
displaying the first review information on a book reading interface of the first book.

2. The method according to claim 1, wherein the first review information is determined by:
determining, among the book-related contents of the first book, the book-related content matching the reading progress information; wherein the book-related contents comprise at least one of: review information of the first book or book-related topics of the first book; and
determining the first review information based on the matched book-related content.

3. The method according to claim 2, wherein determining the first review information based on the matched book-related content comprising:
in a case where the reading mode is a first reading mode, acquiring alternative review information matching the reading progress information from the review information of the first book; wherein the first reading mode is used to indicate that the chapter that has been read does not comprise last chapter; and
determining, among the alternative review information, one piece of the alternative review information that meets a review quality requirement for the chapter that has been read, and determine the first review information based on the one piece of the alternative review information that meets the review quality requirement.

4. The method according to claim 2, wherein determining the first review information based on the matched book-related content comprising:
in a case where the reading mode is a second reading mode, determining, among the book-related topics of the first book, a first book-related topic matching the reading progress information; wherein the second reading mode is used to indicate that the chapter that has been read comprises last chapter; and
determining the first review information based on the first book-related topic.

5. The method according to claim 4, wherein the first review information comprises a topic expansion identifier; the method further comprising:
in response to a triggering operation on the topic expansion identifier, jumping to a topic aggregation page; and
displaying a second book-related topic on the topic aggregation page; wherein the second book-related topic is a topic belonging to a target dimension among the book-related topics, and the target dimension comprises at least one of: a target content type of a topic content, or a target creation type of the related book.

6. The method according to claim 1, wherein the first review information comprises text review information; and displaying the first review information on the book reading interface of the first book comprising:
extracting key text information from the text review information;
displaying the key text information in a review display area other than the display area of the first book in the book reading interface, and displaying a text expansion identifier; and
in response to a triggering operation on the text expansion identifier, displaying the text review information in the review display area.

7. The method according to claim 6, wherein the method further comprising:
in a case where the triggering operation on the text expansion identifier is not detected and a reading operation on a target chapter of the first book is detected, acquiring second review information matching the target chapter; wherein the target chapter is another chapter after the chapter that has been read;
determining a position of a designated chapter in the book reading interface; wherein the position of the designated chapter is an area other than a chapter content of the target chapter in the book reading interface; and
displaying the second review information at the position of the designated chapter.

8. The method according to claim 1, wherein displaying the first review information on the book reading interface of the first book comprising:
determining whether the review display area other than the display area of the first book in the book reading interface meets a display requirement; and
in a case where the display requirement is met, displaying the first review information in the review display area of the book reading interface; wherein it is indicated that the first review information and part of a chapter content of the chapter that has been read are displayed on the same book reading interface when the display requirement is met.

9. The method according to claim 8, wherein displaying the first review information on the book reading interface of the first book comprising:
in a case where the display requirement is met, displaying a book detail extension identifier in the review display area of the book reading interface, and
in response to a triggering operation on the book detail extension identifier, jumping to a book detail page, wherein the book detail page comprises at least one of: information about an author of the first book, update information of the first book, rating information of the first book or review information of the first book.

10. A computer apparatus comprising a processor, a memory, and a bus, wherein the memory stores machine-readable instructions executable by the processor, when the computer apparatus is running, the processor communicates with the memory through the bus, and when the machine-readable instructions are executed by the processor, the processor is configured to:
acquire reading progress information of a first book; wherein the reading progress information is used to indicate chapter that has been read by a user of the first book;
determine a reading mode of the first book based on the reading progress information, and acquire first review information of the chapter that has been read matching the reading mode; wherein the first review information is determined based on a book-related content corresponding to the reading progress information; and
display the first review information on a book reading interface of the first book.

11. The computer apparatus according to claim 10, wherein the processor is further configured to:
determine, among the book-related contents of the first book, the book-related content matching the reading progress information;
wherein the book-related contents comprise at least one of: review information of the first book or book-related topics of the first book; and
determine the first review information based on the matched book-related content.

12. The computer apparatus according to claim 11, wherein the processor is further configured to:
in a case where the reading mode is a first reading mode, acquire alternative review information matching the reading progress information from the review information of the first book; wherein the first reading mode is used to indicate that the chapter that has been read does not comprise last chapter; and
determine, among the alternative review information, one piece of the alternative review information that meets a review quality requirement for the chapter that has been read, and determine the first review information based on the one piece of the alternative review information that meets the review quality requirement.

13. The computer apparatus according to claim 11, wherein the processor is configured to:
in a case where the reading mode is a second reading mode, determine, among the book-related topics of the first book, a first book-related topic matching the reading progress information; wherein the second reading mode is used to indicate that the chapter that has been read comprises last chapter; and
determine the first review information based on the first book-related topic.

14. The computer apparatus according to claim 13, wherein the first review information comprises a topic expansion identifier; the processor is configured to:
in response to a triggering operation on the topic expansion identifier, jump to a topic aggregation page; and
display a second book-related topic on the topic aggregation page; wherein the second book-related topic is a topic belonging to a target dimension among the book-related topics, and the target dimension comprises at least one of: a target content type of a topic content, or a target creation type of the related book.

15. The computer apparatus according to claim 10, wherein the first review information comprises text review information; and the processor is configured to:
extract key text information from the text review information;
display the key text information in a review display area other than the display area of the first book in the book reading interface, and display a text expansion identifier; and
in response to a triggering operation on the text expansion identifier, display the text review information in the review display area.

16. The computer apparatus according to claim 15, wherein the processor is configured to:
in a case where the triggering operation on the text expansion identifier is not detected and a reading operation on a target chapter of the first book is detected, acquire second review information matching the target chapter; wherein the target chapter is another chapter after the chapter that has been read;
determine a position of a designated chapter in the book reading interface; wherein the position of the designated chapter is an area other than a chapter content of the target chapter in the book reading interface; and
display the second review information at the position of the designated chapter.

17. The computer apparatus according to claim 10, wherein the processor is configured to:
determine whether the review display area other than the display area of the first book in the book reading interface meets a display requirement; and
in a case where the display requirement is met, display the first review information in the review display area of the book reading interface; wherein it is indicated that the first review information and part of a chapter content of the chapter that has been read are displayed on the same book reading interface when the display requirement is met.

18. The computer apparatus according to claim 17, wherein the processor is configured to:
in a case where the display requirement is met, displaying a book detail extension identifier in the review display area of the book reading interface, and
in response to a triggering operation on the book detail extension identifier, jumping to a book detail page, wherein the book detail page comprises at least one of: information about an author of the first book, update information of the first book, rating information of the first book or review information of the first book.

19. A non-transitory computer-readable storage medium, wherein a computer program is stored on the computer-readable storage medium, and when the computer program is executed by a processor, the processor is configured to:
acquire reading progress information of a first book; wherein the reading progress information is used to indicate chapter that has been read by a user of the first book;
determine a reading mode of the first book based on the reading progress information, and acquire first review information of the chapter that has been read matching the reading mode; wherein the first review information is determined based on a book-related content corresponding to the reading progress information; and
display the first review information on a book reading interface of the first book.
